(19) United States
(12) Patent Application Publication
(10) Pub. No.: US 2006/0145436 A1
(43) Pub. Date: Jul. 6, 2006

(54) Shopping cart mounted step stool

(76) Inventor: Domenick R. Varricchio, Fort Lee, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/026,730

(22) Filed: Jan. 3, 2005

(51) Int. Cl. B62D 39/00

(52) U.S. Cl. 280/33.992

(57) ABSTRACT

A foldable, portable step stool constructed of at least one flat planar surface, or platform that can be combined with a vehicle used to transport a load. The flat planar surfaces are connected by foldable joints and folded against each other for storage in the space between the storage area and the wheel base of the vehicle. The flat planar surfaces are unfolded to create one unified surface, the platform of the step stool. The platform is supported by legs connected to the underside of one or more of the flat planar surfaces. The legs are situated to be out of the way when the step stool is folded. Within each leg is a spring mounted wheel caster mechanism that retracts into the leg when weight is applied to the stool in its deployed position. Non-slip pads also prevent the legs from moving in the deployed position.

### CROSS-REFERENCE TO RELATED APPLICATIONS

Not applicable.

### FEDERALLY SPONSORED RESEARCH OR DEVELOPMENT

Not applicable.

### SEQUENTIAL LISTING

Not applicable.

### BACKGROUND OF THE INVENTION

1. Field of the Invention

This invention is related to the field of devices utilizing a supported planar surface or surfaces (“platform” or “platforms”) in combination with devices or structures having another function. It is a step stool constructed in a manner such that it can be portably combined with a vehicle used to transport a load, such as a shopping cart. In other embodiments, it is the apparatus combining a shopping cart and step stool.

2. Description of the Related Art

Vehicles used to transport a load, such as a shopping cart employing a basket mounted on a wheeled base, are utilized extensively in supermarkets, department stores and the like. In the form of a shopping cart, they are generally constructed of a plurality of metal or plastic wire and tubular members and joint fittings, but can be constructed of a multitude of materials and in a multitude of styles. For example, the cart could be made entirely of wood or fiberglass, and the basket could be an enclosed box, or it could be a shallow tray. The base generally will ride on three or four wheels, with at least the front wheels attached to the base as part of a caster assembly on a pivoting shaft so that they can be turned by the user with the application of a small angled force on the handgrip. The rear wheels may be similarly pivotable for added maneuverability but this is not necessary.

The handgrip will generally be positioned so that it is slightly raised above the rear end of the basket, and will be attached thereto by a structure connecting the handgrip and basket with the base. The handgrip is generally perpendicular to the center line of the cart, the center line being characterized as the line from the back to the front of the cart also representing the direction of travel. Shopping cart technology is a well developed field, extensive and varied. For example, U.S. Pat. No. 2,479,530 to Watson (1949), U.S. Pat. No. 2,556,532 to Goldman (1951), U.S. Pat. No. 2,590,285 to Wiltshire (1952), U.S. Pat. No. 2,596,775 to Kasper (1952), U.S. Pat. No. 3,614,133 to Ganci (1971), U.S. Pat. No. 3,999,774 to Rehrig (1976), and U.S. Pat. No. 6,488,292 to O'Quin (2002).

Similarly, step stools are common. In its simplest form a step stool will consist of a flat surface supported by three or four legs connected to the bottom of the flat surface. The top of the flat surface can be bare, or covered with a textured or contoured surface for comfort or grip. The stool can be used for sitting or standing, in either case giving the user more elevation than would otherwise be available. A step stool is generally considered to be a stool small enough in size and low enough to the ground to be easily ascended in one step. As such, it is generally used to functionally increase the height of the user by the equivalent of the height of the step. While there is no specific height limitation or requirement, a step stool could generally be expected to range between 6 and 18 inches (between 15 and 45 centimeters) in height. A step stool can have more than one step, the principle remaining the same, but with each step ascended increasing the overall height of the user. A step ladder would follow the same concept, but would necessarily have several steps ascending in height while a step stool can have one or more than one step. As step ladders are larger, they are often foldable so that they are more conveniently transported and stored.

Step ladders and step stools being low-tech, easy to use, and very utilitarian, they have been developed extensively in combination with other devices. This includes devices for which the primary use is transporting a load. For example, see U.S. Pat. No. 6,158,749 to Roudebush (2000) and U.S. Pat. No. 4,235,449 to Tarran (1980). These two patents are to a step stool and dolly apparatus (Roudebush) and a combined hand truck and step stool (Tarran), respectively.

Roudebush discloses a folding step stool that is convertible into a hand truck, apparently using the words hand truck and dolly interchangeably. The Roudebush apparatus has two steps in its stool configuration and the entire apparatus folds substantially flat for storage. In its dolly configuration, it has a bottom pivotable dolly unit that is coupled to the front frame member. The load to be carried can thus be placed on the dolly and the apparatus tilted to free the wheels for rolling the apparatus and load. This apparatus can be used only to transport certain types of load. This would include large, heavy, single items within the size and weight range that can be manipulated by a person. For example, large boxes of warehoused items. Smaller items would tend to slip off and would not be worth the trouble of positioning on the dolly. Multiple items would be untenable except for the limited ability to stack them vertically, single file, one on top of another, but this would still be limited by the ability of the user to balance the items during transit. The step stool in the Roudebush apparatus cannot be used simultaneously with the dolly apparatus. The dolly and the step stool are mutually exclusive configurations. The hand truck and step stool configurations are likewise mutually exclusive in the Tarran apparatus. In terms of its function, and in every way relevant to the present application, Tarran is similar to Roudebush.

The apparatus of the present invention allows use as both a step stool and shopping cart simultaneously. In fact, its greatest utility is that it is can be used as both items at the same time. Of course, it can also be used as a shopping cart or step stool alone should that suit the needs of the user. Its utility as a vehicle used to transport a load has the same advantages over a dolly that would be evidenced by a comparison between any standard dolly and any standard shopping cart. It can be used to carry many items simultaneously without the need to stack the items and balance them precisely, and it can be used to carry as heavy a single item as the user can lift into the basket alone or assisted. The net maximum load that can be so transported is at least as heavy as that which can be carried by the dolly, being limited only by the dimensions of the particular basket (which can be varied at time of construction) and the maximum load that can be pushed by the user.

Its utility as a step stool is greatly enhanced by its particular portability between the basket and base of a shopping cart. Thus it will be automatically transported wherever the shopping cart goes, and the user can fold it out and use it to gain extended reach height at the user's convenience.

### BRIEF SUMMARY OF THE INVENTION

The step stool can be mounted on the base of a shopping cart such that it can be folded or flipped into the space between the base and basket of the cart for easy storage and transport. It can be mounted on the front or back of the cart, with the preferred embodiment attached to the front of the cart. When deployed (unfolded or unflipped) onto a floor surface, it will provide additional extended reach height when stepped upon by a person.

The height of the step stool can correspond to the storage space available between the basket and base of the respective shopping cart design model. The stool can be mounted manually with hinges. Spring-loaded retractable wheels are enclosed within the legs. These wheels compress upon application of a downward force, as would result from a person stepping on the stool, with the result being that the wheels retract within the legs, leaving the surrounding legs to grip the floor surface. When weight is not being applied, the wheels thus extend outward beneath the legs, allowing the stool to be rolled along with the cart in its open position.

It can be made of stainless steel, plastic, or any other material of sufficient strength to support the weight of a person. It would likely be most convenient to construct the step stool out of the same material as the shopping cart. The shopping cart also can be constructed of a wide range of materials. Additional features of the present invention will become apparent to those skilled in the art upon consideration of the claims and the following detailed description of preferred embodiments exemplifying the best mode of carrying out the invention as presently perceived.

### BRIEF DESCRIPTION OF THE SEVERAL VIEWS OF THE DRAWINGS

FIGS. 1A through 1C are profile views of the preferred embodiment. FIG. 1A shows the invention with the step stool in flipped, or stored, position. FIG. 1B shows the invention with the step stool in its deployed position (unfolded, or unflipped). FIG. 1C shows the invention in use.

FIG. 2 is a perspective view of the step stool only, with an exploded view of the hinge. The dashed line represents the part of the base of the cart to which the hinge connects.

FIGS. 3A and 3B show a cut away view of a leg of the step stool with the inner wheel mechanism exposed. FIG. 3A shows the leg with the wheel retracted upon the application of a downward force (a weight on the stool). FIG. 3B shows the wheel in its unforced state (extended from the bottom of the leg).

FIGS. 4A through 4C show another embodiment of the stool, with a two part hinged platform. FIG. 4A shows the stool in closed, folded position. FIG. 4B shows it midway through unfolding. 4C shows the stool completely unfolded.

FIG. 5 shows a detachable embodiment of the stool attachment with a one part platform and a curved screwless hinge.

FIG. 6 shows the same embodiment as FIG. 5, attached to the base of a shopping cart.

FIG. 7 shows the relative dimensions of various parts of the apparatus.

### REFERENCE NUMERALS IN DRAWINGS

10 Underside of stool platform
11 Top side of stool platform
12 Stool platform
13 Front section of two part stool platform
14 Joint of Hinge 46 Attaching Platform to wheel base
15 Back section of two part stool platform
16 Front bar of shopping cart wheel base
17 bottom front edge of shopping cart basket
18 Slide resistant floor pad
19 Stud
20 Wheel caster mechanism
21 Wheel inside stool leg
22 Bottom of shopping cart basket
23 Spring
24 Top of shopping cart wheel base
25 Mounting bolt
26 Bottom of shopping cart wheel base
27 Strut inside stool leg
28 Back bar of shopping cart wheel base
29 Washer, nut, or o-ring
30 Strut attaching front wheel to wheel base
31 Shopping cart wheel base
32 Shopping cart front wheel
34 Strut attaching rear wheel to wheel base
36 Rear wheel of shopping cart
38 Basket
40 Shopping cart basket support and hand grip
42 Stool leg
43 Stool leg
44 Textured surface of platform
45 Hinge of two part platform
46 Hinge connecting stool to wheel base
47 Curved member for attachment to wheel base
48 Bolt or screw securing hinge to wheel base
49 Nut or washer securing 48

### DETAILED DESCRIPTION OF THE INVENTION

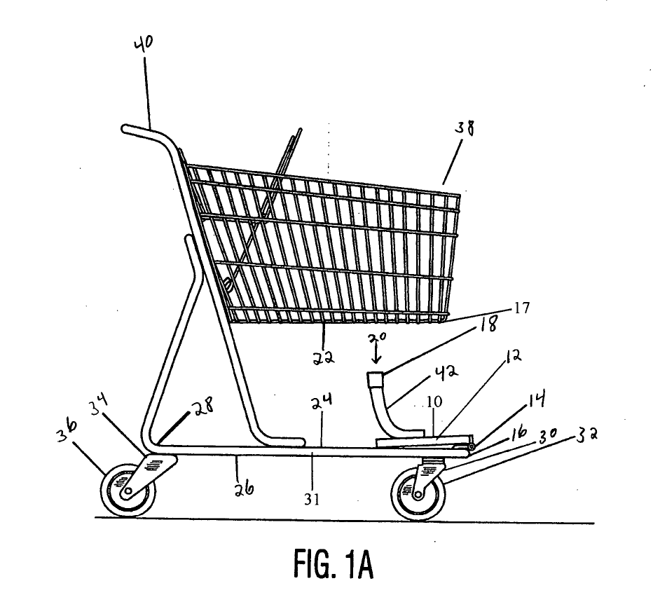

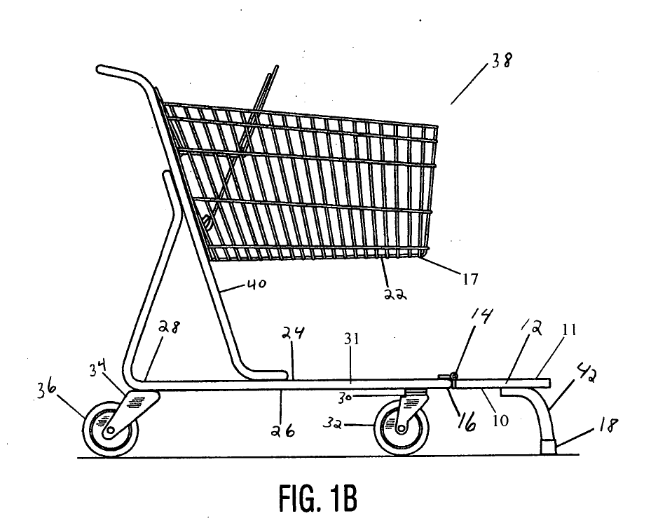

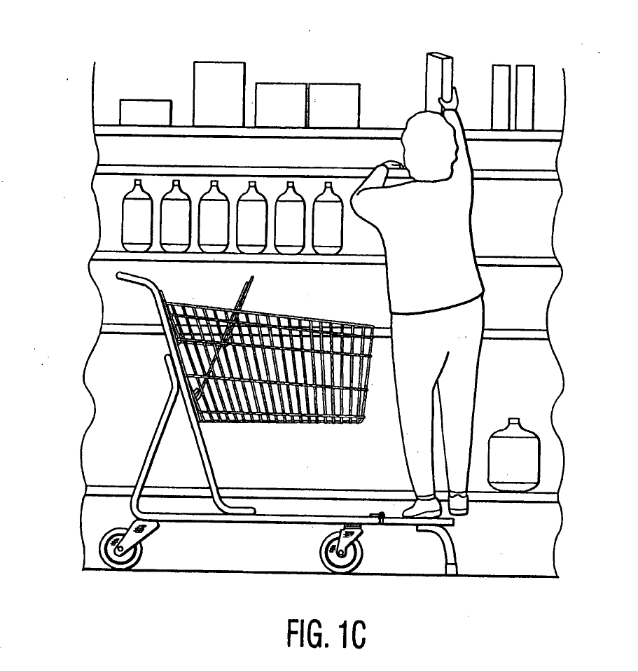

In its preferred embodiment, shown in FIGS. 1 through 3 and 7, this invention is a shopping cart 38 with basket 22 and four wheels 36 and 32 (two shown) on a wheel base 31, and a step stool with a solid one part platform 12 mounted on the front end of the wheel base 16 with a hinge 14 fixed in place by screws or bolts secured by washers or nuts. This embodiment is preferred due to its simplicity rather than any additional functionality over other embodiments. FIG. 1A shows a profile view of this embodiment with the step stool in retracted, folded, or flipped position.

FIG. 1B shows the embodiment in its deployed, unflipped or unfolded position. Essentially, flipped or folded is the storage position, with the stool between the top of the wheel base 24 and basket 22 of the shopping cart 38. The step stool is used in its deployed, unflipped or unfolded position. A step stool in accordance with this invention will have a platform 12. The platform 12 in the preferred embodiment is comprised of only one solid flat piece. Two legs 42 with internal wheel casters 20 are attached to the underside of the platform 10. The bottom of each leg is capped with a slide resistant pad 18.

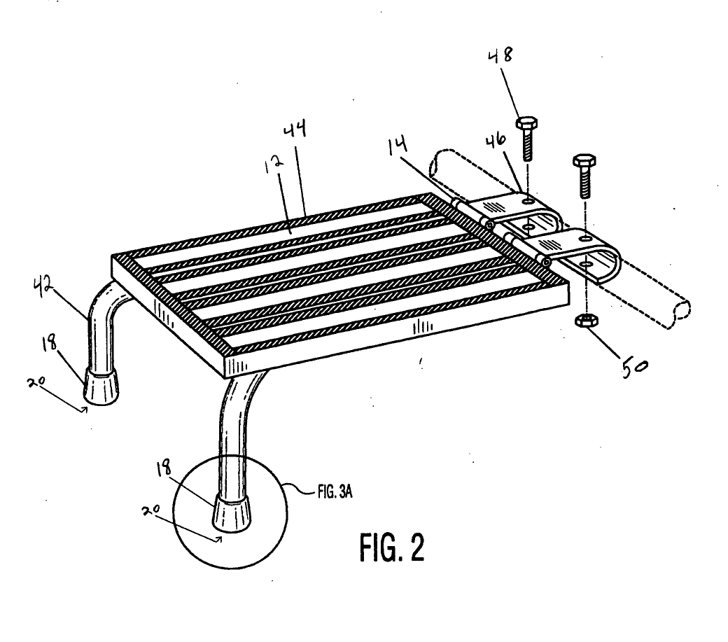

FIG. 2 shows a close-up view of the stool with an exploded view of the connection between stool platform 12 and wheel base 31. The hinge 14 connects the stool platform 12 to the shopping cart wheel base 31 with screws or bolts 48 inserted through the hinge 14 and secured by nuts or washers 50. The hinge 14 includes a flange 46 that is flat where it extends out from the joint in the hinge, but curved around the wheel base 31 to fit securely. The flange 46 includes holes in both the portion that passes across the top of the wheel base 31 and the portion that curves beneath the wheel base 31 so that each bolt 48 passes through the flange 46 twice.

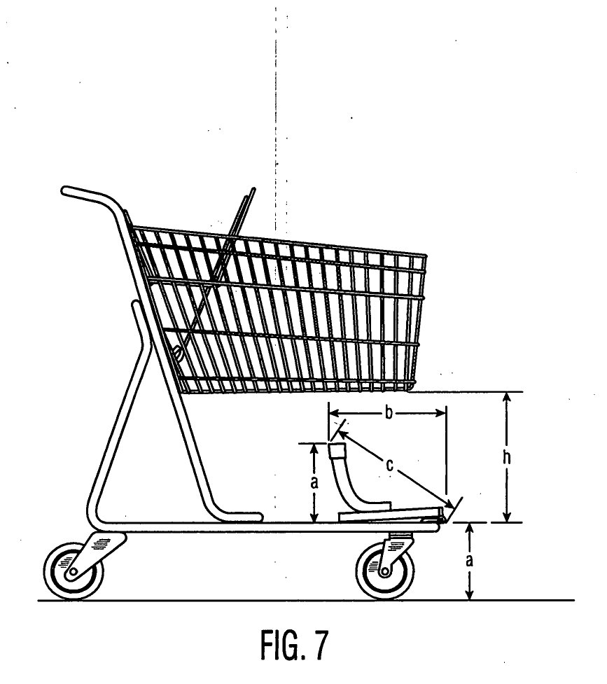

The dimensions of the step stool are shown in FIG. 7 and determined by the requirement that the stool fit the intended shopping cart. The distance from the top of the platform 11 to the bottom of the pad 18 on each leg 42 should be about the same as the distance from the top of the wheel base 24 to the bottom of the front wheel 32. This is shown in FIG. 7 as distance “a.” The distance from the hinge joint 14 to the forward bottom edge of the pad 18, “c” in FIG. 7, can be no larger than the closest approach distance from the hinge joint 14 to the bottom front edge of the shopping cart basket 17. In order to guarantee maximum compatibility of the stool without regard to the exact dimensions of the basket 38 relative to the wheel base 31, the length of the stool from front to back “b” should be less than the distance from the top of the wheel base 24 to the bottom of the basket 22, “h” in FIG. 7.

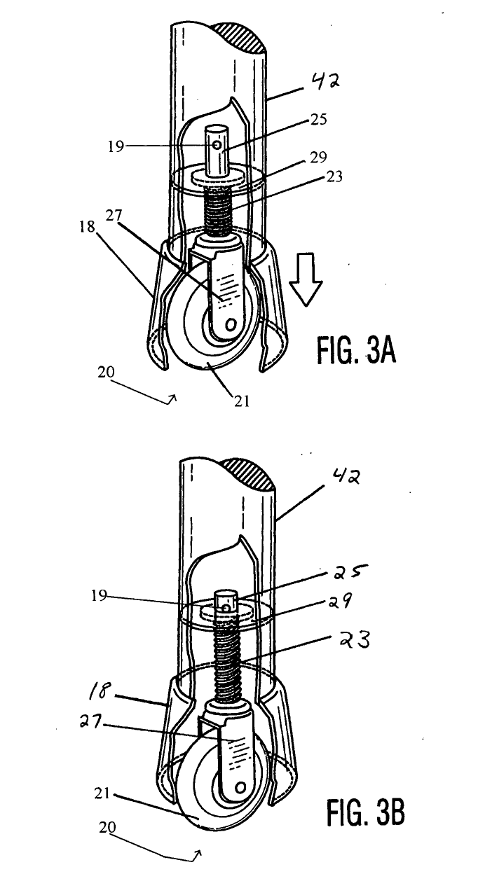

FIGS. 3A and 3B are cut away views of a leg of the stool 42, showing its inner wheel caster mechanism 20. Inside each leg 42 is a wheel caster mechanism 20. The individual stool legs are identical. The description of the mechanism 20 mounted within each leg is the same. The mechanism is affixed to the inside of the leg 42 by a wheel mounting bolt 25. A washer or nut or o-ring 29 holds the mounting bolt 25 in place. The washer 29 is solidly affixed to the inside of the leg 42. The bolt 25 is affixed within the leg 42 in such a way that it is permitted a certain amount of vertical movement but is unable to pass completely through the washer 29. At its top, the bolt 25 is held above the washer by a stud or other protrusion 19. A strut 27 is attached to the base of each bolt 25. A wheel 21 is attached within each strut 27 and is braced and held in place by the strut 27. A spring 23 is placed around the mounting bolt 25 above the strut 27. The spring 23 is restricted above by the washer or o-ring 29. The washer 29 completely encircles the mounting bolt 25 so that the spring is confined between the strut 27 and the washer 29.

The embodiment in FIGS. 1 through 3 and 7 operates as any shopping cart would, with the exception that it carries with it a step stool stored in part of the space between the top of the wheel base 24 and the bottom of the basket of the cart 22. When the person using the device needs to use the stool, it can be flipped into position by merely grabbing one of the legs 42, or the platform 12 and pulling upward and/or outward so that the entire stool turns on its hinges 14. The stool is turned (deployed or unflipped) until the slide resistant floor pads 18 on the bottom of each leg 42 are flush with the floor. The top of the platform 11 will then be parallel with the floor, and the user can stand on it, or sit on it, or use it for any other purpose suitable for a stool. The top of the platform 11 may include a textured surface 44 or other added surface element to increase friction and prevent sliding.

The wheel caster mechanism 20 within each leg 42 of the stool allows the stool to roll on the floor along with the rest of the shopping cart as long as no downward weight is applied to the top of the stool. The spring 23 on the mounting bolt 25 within each mechanism 20 provides a persistent force tending to keep the wheel 21 clear of the bottom of the floor pad 18 at the bottom of each leg 42. Thus the wheel 21 remains free to roll provided no weight is on the stool. When a weight is applied to the top of the stool the spring 23 contracts, causing with wheel 21 to withdraw into the leg 42 of the stool until virtually all of the weight on the stool is supported by the floor pad 18 at the foot of each leg 42. In this manner, the stool is held in place when weight is applied, but can roll along with the cart when no weight is applied to the stool.

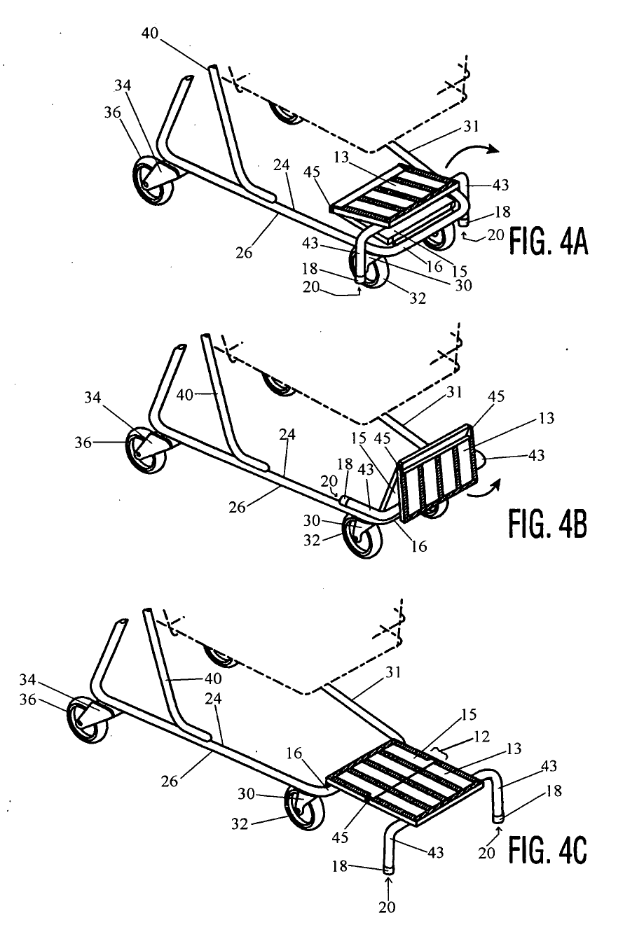

FIGS. 4A-C show another embodiment of the invention. In this embodiment, the step stool platform is a two part affair. The front section of the platform 13 is connected to the back section of the platform 15 with a hinge or other folding joint 45. The back of the platform 15 then connects with the wheel base 31 by way of the same type hinge 46 that connects the platform in the earlier embodiment.

Each leg 43 of this embodiment is attached to the front section of the platform 13 in a manner such that the leg drops off to the left or right side of the platform respectively, so that the legs will fit out of the way when the stool is folded. In this particular representation of this embodiment, the bend in each leg is slightly more pronounced than in the preferred embodiment, with the part connected to the underside of platform 13 extending laterally outward slightly further in order to facilitate the leg fitting around the wheel base 31 when the stool is folded. In other respects each leg 43 is the same as each leg 42 in the earlier embodiment, with floor pad 18 and wheel mechanism 20. There is quite a bit of leeway regarding the exact shape of each leg in either embodiment, and it would be possible for the same leg to be used in either. The preferred embodiment has more leeway in this matter, as the legs do not need to fit around any other part when the stool is folded.

The embodiment shown in FIGS. 4A-C operates as the previous embodiment by providing a step stool stored between the wheel base 31 and basket 38. The hinge 45 in the platform 12 allows the front of the platform 13 to fold against the back of the platform 15 so that the bottom of each part rests against the bottom of the other. This is shown in FIG. 4B. The folded stool is then stored when the back of the platform 15 flips over the wheel base 31 using hinge 46 in the same manner as accomplished in the earlier embodiment. This is shown in FIG. 4A. The different positioning of the legs 43 in this embodiment allows them to easily fit alongside the wheelbase 31 when the stool is folded and stored. The two part platform can thus be stored in a smaller area than would otherwise be possible for the same size stool if the platform were one piece. By allowing for the platform to fold for storage, therefore, the embodiment shown in FIGS. 4A-C can also accommodate a larger total stool platform 12 when the stool is completely unfolded than would be possible in the earlier, simpler preferred embodiment.

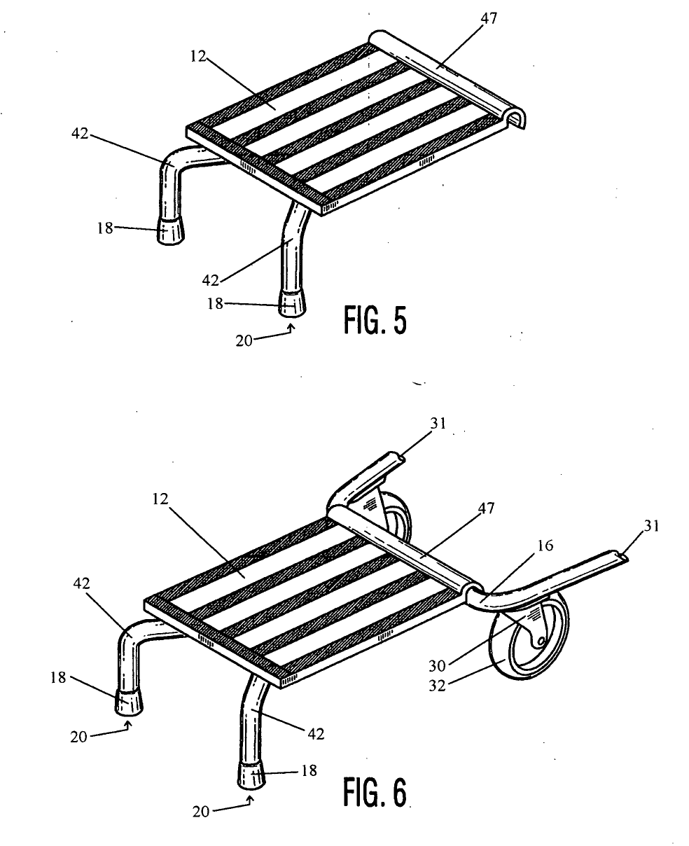

FIGS. 5 and 6 show another embodiment of this invention. While its platform and legs and the parts thereof are similar to the preferred embodiment in other ways, in this embodiment the shopping cart step stool platform 12 includes a curved screwless hinge or hooking member at the back 47. This is in lieu of the hinge 46 and joint 14 in the preferred embodiment. Said curved member 47 extends across the entire width of the stool platform 12 and is fitted to be readily attachable to the wheel base 31 of a shopping cart.

This embodiment can be carried separately from the cart and attached to the wheel base when needed.

The novel utility of the embodiments of this device are distinct from the normal utilities that would be expected from a shopping cart or step stool alone. This device provides an always present readily available step stool. Since the stool is portably transported along with the shopping cart it is always at hand when needed, whenever the shopping cart is in use, with no additional requirement to remember to bring it along. The stool can be quickly unfolded and used to access elevated objects with minimal effort, then just as easily stored and forgotten, yet it will always be thoughtlessly and effortlessly present whenever it is needed.

Although the invention has been described above in detail with reference to certain preferred embodiments and the description contains many specifics, these should not be construed as limiting the scope of the invention. They merely provide illustrations of some of the presently preferred embodiments of this invention. Variations and modifications exist within the scope and spirit of the invention as described and as defined in the following claims. Thus the scope of the invention should be determined by the appended claims and their legal equivalents, rather than by the given examples.

I claim:

1. A portable step stool comprised of:
a) one or more flat planar surfaces that may be folded into and stored in the space between the wheel base and storage area of a vehicle used to transport a load, such as a shopping cart, and then unfolded for use as a step stool adjacent to said vehicle, and
b) two or more legs or similar support means connected to one or more of the flat planar surfaces, situated in such a way that they provide support for the step stool in its deployed position while remaining out of the way to allow the flat planar surfaces to fold into the aforementioned space.

2. A step stool as in claim 1, further comprising a member connected to one said flat planar surface, said member being constructed of sufficiently flexible material and being of sufficient dimensions:
a) to allow the step stool to be connected to the vehicle when needed,
b) to allow the step stool to be detached from the vehicle when desired, and
c) to function as a foldable joint allowing said step stool to fold into the space between the wheel base and the basket of the vehicle when connected to said vehicle.

3. A step stool as in claim 2, further comprising one or more additional foldable joints, such that each additional flat planar surface, if more than one are used, is connected to its neighboring flat planar surface or surfaces by one or more foldable joints in such a way that the flat planar surfaces can be folded back upon each other to fit into the space between the storage area and the base of the vehicle and unfolded to form the contiguous flat surface of the step stool.

4. An apparatus as in claim 3, in which the additional foldable joints are hinges.

5. An apparatus as in claim 3, further comprising a slide resistant material molded to fit over the foot of the step stool leg, in such a way that the slide resistant material encloses the foot of each leg of the step stool in a slide resistant pad.

6. An apparatus as in claim 5, in which a wheel caster mechanism is incorporated within each leg of the step stool.

7. An apparatus as in claim 6, in which the wheel caster mechanism is spring-mounted so that the wheel retracts within the step stool leg when weight is applied to the step stool platform in its deployed position, thereby allowing contact between the floor and the slide resistant pad.

8. An apparatus comprised of:
a) a shopping cart and
b) a step stool
in combination, such that said step stool may be folded into and stored in the space between the wheel base and the basket of said shopping cart and then unfolded for use as a step stool adjacent to the shopping cart.

9. An apparatus as in claim 8, in which the platform of the step stool is comprised of one or more flat planar surfaces.

10. An apparatus as in claim 8, further comprising two or more legs or similar support means connected to one or more of the flat planar surfaces, situated in such a way that they provide support for the step stool in its deployed position while remaining out of the way to allow the flat planar surfaces to fold into the space between the wheel base and the basket of said shopping cart.

11. An apparatus as in claim 10, further comprised of one or more foldable joints, such that:
a) one of said flat planar surfaces is connected to said shopping cart by one or more of the aforementioned foldable joints, and
b) each additional flat planar surface, if more than one are used, is connected to its neighboring flat planar surface or surfaces by one or more foldable joints, in such a way that the flat planar surfaces can be folded back upon each other to fit into the space between the basket and the base of the shopping cart and unfolded to form the contiguous flat surface of the step stool.

12. An apparatus as in claim 11, in which the foldable joints are hinges.

13. An apparatus as in claim 11, further comprising a slide resistant material molded to fit over the foot of the step stool leg, in such a way that the slide resistant material encloses the foot of each leg of the step stool in a slide resistant pad.

14. An apparatus as in claim 13, in which a wheel caster mechanism is incorporated within each leg of the step stool.

15. An apparatus as in claim 14, in which the wheel caster mechanism is spring-mounted so that the wheel retracts within the step stool leg when weight is applied to the step stool platform in its deployed position, thereby allowing contact between the floor and the slide resistant pad.
